(19) United States
(12) Patent Application Publication
(10) Pub. No.: US 2021/0192417 A1
(43) Pub. Date: Jun. 24, 2021

(54) Method for calculating activity duration and efficiency

(71) Applicant: National Health Research Institutes, Miaoli County (TW)

(72) Inventor: Yu-Hsuan Lin, Miaoli County (TW)

(21) Appl. No.: 17/124,550

(22) Filed: Dec. 17, 2020

Related U.S. Application Data
(60) Provisional application No. 62/949,671, filed on Dec. 18, 2019.

(51) Int. Cl. G06Q 10/06; H04L 29/08; G01S 19/01

(52) U.S. Cl. CPC G06Q 10/06398; G01S 19/01; H04L 67/22

(57) ABSTRACT

The present invention is a method for calculating activity duration comprises collecting user data, dividing the user data into in-range and out-range node, setting the in-range node as activity start node or activity end node, setting one of the activity start/end node as period start/end node, and let the period time differential between the period start node and period end node as activity duration. A method for calculating activity efficiency comprises collecting the usage data of the mobile device, label the usage data based on the activity duration, set the labeled usage data as the dataset, and train a neural network with the dataset, wherein the trained neural network generates a feature based on the usage data, and calculate the efficiency based on the feature. The present invention greatly improves efficiency for labor inspection, and helps people with erratic work schedules to have better benefits.

### CROSS-REFERENCE TO RELATED APPLICATIONS

The present application claims an invention which was disclosed in Provisional Application No. U.S. 62/949,671 filed Dec. 18, 2019, entitled “Method of Automatically Calculating Workhours and Work Pattern through Mobile Application Based on Global Positioning System Background Data”. The benefit under 35 USC § 119(e) of the United States provisional application is hereby claimed, and the aforementioned application is hereby incorporated herein by reference.

### FIELD OF THE INVENTION

The present invention relates generally to a method and system that automatically calculates its activity duration and activity efficiency based on the automatically recorded locations and actions. This invention is particularly useful in the field of human resource management, such as checking an attendance and performance of an employee.

### BACKGROUND OF THE INVENTION

Long work hours and shift work increase the risk of both physiological and psychological distress, including cardiovascular disease and depressive symptoms. Systematic reviews have reported that such long working shifts and erratic schedules result in numerous adverse consequences in patient care.

Nowadays, smartphones offer us an objective and ecological source of measurement that continuously and passively collects data. These reliable, quantitative data could facilitate real-time policy evaluation and target resources to those with the greatest need for them, even in remote and inaccessible regions. As of July 2019, hundreds of mobile applications (apps) dealing with the tracking of workhours. However, the vast majority of those apps require manual entries or actively clocking in and out. Those apps could not meet physicians' requirements since they often have to move between hospitals and have several on-call duties every month. During their on-call duty, physicians have to stand by in the hospital or be on-call at home. A simple GPS geo-fencing algorithm could not identify these patterns of workhours.

In addition, the work hours identified by a simple GPS geo-fencing algorithm did not reflect the physician's real status. For example, the physician may take his lunch in the hospital during the lunch break; however, the GPS geo-fencing algorithm will still deem the physician is still practicing medicine during the lunch break.

### SUMMARY OF THE INVENTION

The present invention provides a method for calculating activity duration and efficiency, which automatically calculates users' workhours through Global Positioning System (GPS) data and usage behavior on the phone. This invention would not need users to precisely log their workhours by manual input or clocking in and out of work. The specific aims of the invention are:
1. Automatically tracks the working hours of an employee.
2. Integrate the working hours at different places into one activity duration.
3. Calculate the efficiency of the employee based on their usage behavior of the phone.
4. Calculate the weighted activity duration based on the efficiency and the activity duration.

The present invention provides a method for calculating activity duration and efficiency, which begins with setting a range of activity and automatically collecting the user's GPS data. The method divides the GPS data into in-range node and out-range node based on the range of activity; then, the in-range nodes is set as an activity start nodes or an activity end nodes based on the amount of nodes that adjacently to the in-range nodes and out-range nodes. The method then sets one of the activity start nodes as the period start node and one of the activity end nodes as the period start node based on the pattern of which constitute by the activity start node and activity end node. Finally, the activity duration will be generated by calculating the time differential between the period start node and the nearest period end node after the period start node.

The present invention further provides an activity efficiency calculation system comprising a data processing module, probability module, and neural network series. The system automatically tracks the user's usage data on his smartphone and analyzes the usage data by the neural network series. The analysis result will be inputted to the probability module and outputted an activity efficiency of the user. Wherein, the usage data is the usage behavior includes the application name data, application category data, screen status data, notification data of the user's phone.

The present invention further provides a method for training activity efficiency calculation system comprises the activity efficiency calculation system and a training system, wherein the training system further comprises a labeling module and training module. The labeling module labels the user data based on the activity duration which generated by the method for calculating activity duration and efficiency, and the training module trains the neural network series by a 5-fold cross validation approach.

The present invention further provides a method for calculating weighted activity duration, which is developed under the method for calculating activity duration and efficiency.

The present invention greatly improves efficiency for labor inspection, and helps people with erratic work schedules to have better benefits.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 shows a schematic view of a system for calculating activity duration and activity efficiency.

FIG. 2 shows a first embodiment of the method for calculating activity duration.

FIG. 3 shows an application scenario of the method for calculating activity duration.

FIG. 4 shows a visualization graph of the method for calculating activity duration in the second embodiment.

FIG. 5 shows a third embodiment of the method for calculating activity duration.

FIG. 6 shows a visualization graph of the method for calculating activity duration in the fourth embodiment.

FIG. 7 shows a visualization graph of the method for calculating activity duration in the fifth embodiment.

FIG. 8 shows a diagram of the activity efficiency calculation system and the training system thereof.

FIG. 9 shows graphic of the sixth embodiment.

FIG. 10 shows graphic of method for calculating weighted activity duration.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below to explain the present invention by referring to the figures.

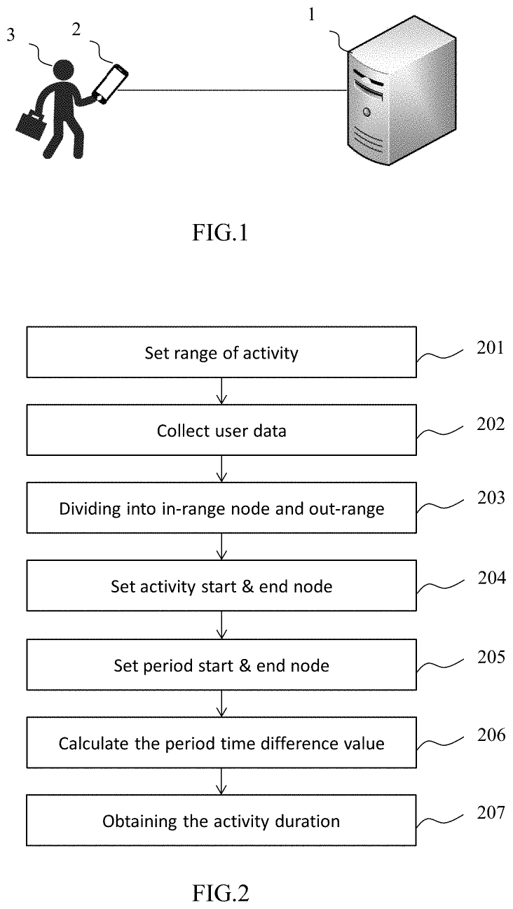

A schematic view of a system for calculating activity duration and activity efficiency is shown in FIG. 1. The system comprises a server 1 and a mobile device 2, wherein the mobile device 2 provides an input interface for user 3 to input a range of activity and the user information. The mobile device 2 also tracks the user data and usage data of the user 3 and transmits the range of activity, the user information, user data, and usage data to the server 1.

The server 1 executes the method for calculating activity duration and activity efficiency, which generates the user's activity duration and efficiency. The user 3 is allowed to see the activity duration and efficiency by an output interface installed in the mobile device 2.

The user data is the Global Positioning System (GPS) data, wherein the GPS data comprise the user's location with a timestamp.

The usage data is the application name data, application category data, screen status data, or notification data, which is recorded based on the user's usage behaviors at each second.

The user information is the user's age, gender, position, department of the position, range of activity or type of the mobile device 2, wherein the type of the mobile device 2 includes public device, private device or personal device.

A first embodiment of the method for calculating activity duration is shown in FIG. 2. In the first embodiment, the method for calculating activity duration begins at step 201 when the user 3 set an activity location by the mobile device 2. At the step 201, the server 1 will automatically set the activity location as the origin and 1 km as radius. And the circle of radius centered at the origin will be the range of activity.

At step 202, the mobile device 2 tracks the user's location every 10 minutes to record the Global Positioning System (GPS) data. The mobile device 2 also transmits the GPS data to the server 1 which allows the server 1 to collect the GPS data as the user data.

At step 203, the server 1 sorts the user data whose location is inside the range of activity as an in-range node and the user data whose location is outside the range of activity as an out-range node.

At step 204, the server 1 sets the in-range node satisfies a first condition as an activity start node and the in-range node satisfies a second condition as an activity end node.

Wherein, the first condition is satisfied when more than 3 continuous out-range nodes disposed adjacently to the front of the in-range node, and more than 3 continuous in-range nodes disposed adjacently to the back of the in-range node.

Wherein, the first condition is also satisfied when the server 1 does not collect any user data before the in-range node, and more than 3 continuous in-range nodes disposed adjacently to the back of the in-range node.

Wherein, the second condition is satisfied when more than 3 continuous out-range nodes disposed adjacently to the front of the in-range node, and more than 3 continuous in-range nodes disposed adjacently to the back of the in-range node.

Wherein, the second condition is also satisfied when the server 1 does not collect any user data before the in-range node, and more than 3 continuous in-range nodes disposed adjacently to the back of the in-range node.

At step 205, the server 1 sets the activity start node satisfies a third condition as a period start node and the activity end node satisfies a fourth condition as a period end node.

Wherein, the third condition is satisfied when the server 1 does not collect any user data before the activity end node.

Wherein, the third condition is also satisfied when the activity start node exists a first out-range time differential, and the first out-range time differential is greater than 8 hours.

Wherein, the activity start node exists the first out-range time differential when one of the out-range nodes is adjacent to the activity start node. Wherein the first out-range time differential is the time differential between the activity start node and the nearest activity end node before the activity start node.

Wherein, the fourth condition is satisfied when the server 1 does not collect any user data after the activity end node.

Wherein, the fourth condition is also satisfied when the activity end node exists a second out-range time difference, and the second out-range time differential is greater than 8 hours.

Wherein, the activity end node exists the second out-range time differential when one of the out-range nodes is adjacent to the activity end node. Wherein, the second out-range time differential is the time differential between the activity end node and the nearest activity start node after the activity end node.

At step 206, the server 1 calculates the period time differential between the period start node and the nearest period end node after the period start node,

At step 207, the server 1 let the period time differential be the first activity duration.

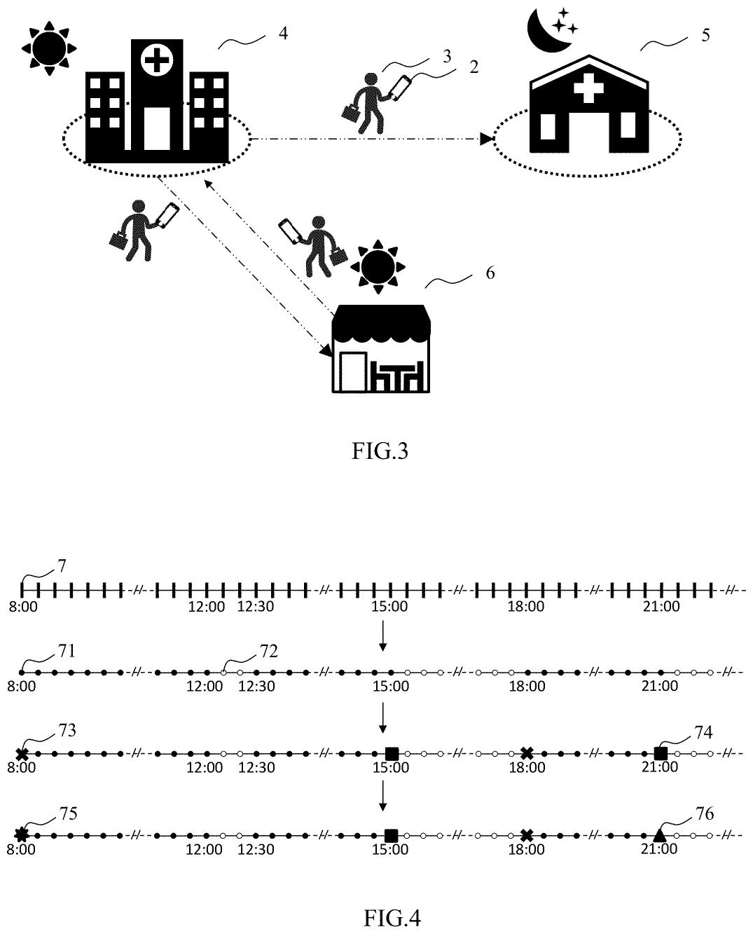

A second embodiment, which is an application scenario of the method for calculating activity duration is shown in FIG. 3. In the application scenario, the user 3 always brings his mobile device 2 with him, and the user 3 is a physician whose activity is practice medicine at a hospital 4 from 8:00 to 15:00, and practice medicine at a clinic 5 from 18:00 to 21:00. Wherein, during the practice at the hospital 4, user 3 takes a short break at a nearby cafeteria 6 from 12:00 to 12:25.

A visualization graph of the method for calculating activity duration in the second embodiment is shown in FIG. 4. In the second embodiment, the user 3 set the hospital 4 and clinic 5 as his activity location through the input interface installed on the mobile device 2, then the server lautomatically set the origin and 1 km as radius. And the circle of radius as 1 km and origin at the hospital 4 and clinic 5 be the range of activity.

In the second embodiment, the mobile device 2 move along with the user 3 and tracks the user's location every 10 minutes to record the user data 7, and transmits the user data 7 to the server 1 which allows the server 1 to collect the user data. Wherein, the user data 7 is a GPS data comprises the timestamp and the latitude and longitude of the user 3 at each particular time.

In the second embodiment, the server 1 sorts the user data 7 collected during 8:00 to 12:00, 12:30 to 15:00, and 18:00 to 21:00 as in-range nodes 71 since these user data 7 is collected when user 3 is located in the range of activity.

In the second embodiment, the server 1 sorts the user data 7 collected during 12:00 to 12:20 and 15:00 to 18:00 as out-range nodes 72 since these user data 7 is collected when user 3 is not located in the range of activity.

In the second embodiment, the server 1 sorts the in-range nodes 71 at 8:00 as activity start node 73 since no user data 7 is collected before the in-range node at 8:00 and more than 3 continuous in-range nodes 71 disposed adjacently to the back of the in-range node 71 at 8:00. The server 1 sorts the in-range nodes 71 at 15:00 as activity start node 73 since more than 3 continuous out-range nodes 72 disposed adjacently to the front of the in-range node 71 at 15:00 and more than 3 continuous in-range nodes 71 disposed adjacently to the back of the in-range node at 15:00.

In the second embodiment, the server 1 sorts the in-range nodes 71 at 15:00 and 21:00 as activity end node 74 since more than 3 continuous in-range nodes 71 disposed adjacently to the back of the in-range nodes 71 at 15:00 and 21:00

In the second embodiment, the server 1 sorts the activity start node 73 at 8:00 as period start node 75 since no activity start node 73 is collected before the activity start node 73 at 8:00.

In the second embodiment, the server 1 sorts the activity end node 74 at 21:00 as period end node 76 since no activity end node 74 is set after the activity end node 74 at 21:00.

In the second embodiment, the server 1 calculates the period time differential between the period start node 75 at 8:00 and period end node 76 at 21:00. The calculation result for the period time differential is 13 hours; therefore, the first activity duration is 13 hours.

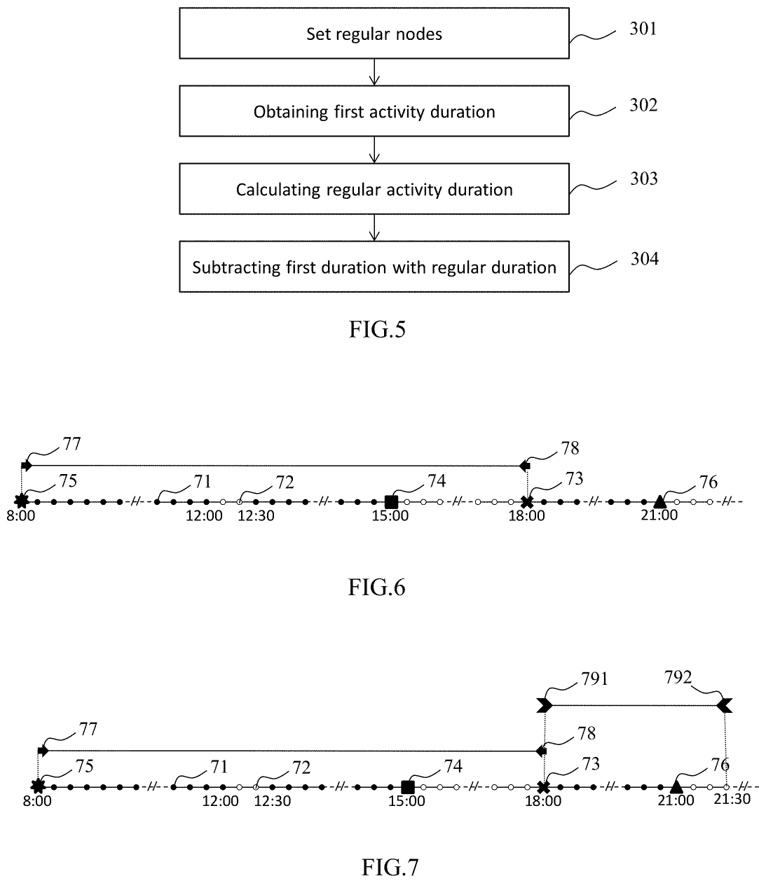

A third embodiment of the method for calculating activity duration is shown in FIG. 5. In the third embodiment, the method for calculating activity duration begins at step 301 when the user 3 set the regular starting time of the activity as the regular start node, the regular ending time of the activity as the regular end node.

At step 302, the sever 1 obtains the period end node and calculates the first activity duration by executing the step 201-206.

At step 303, the server 1 calculates regular time differential between the regular start node and the regular end node, and let the regular time differential be the regular activity duration.

At step 304, the server 1 calculates an overtime differential by subtracting the first activity duration with the regular activity duration, and let the overtime differential be the overtime activity duration.

A visualization graph of the method for calculating activity duration in the fourth embodiment is shown in FIG. 6. In the fourth embodiment, the user set regular start node 77 at 8:00 and the regular end node 78 at 18:00. The period start node is happened at 8:00 and the period end node is happened at 21:00.

At the fourth embodiment, the first activity duration is 13 hours and the regular activity duration is 10 hours. As the result, overtime differential is 3 hours.

A visualization graph of the method for calculating activity duration in the fifth embodiment is shown in FIG. 7. In the fifth embodiment, the user set regular start node 77 at 8:00, the regular end node 78 at 18:00, the standby start node 791 at 18:00, and the standby end node 792 at 21:30. The period start node is happened at 8:00 and the period end node is happened at 21:00.

At the fifth embodiment, the first activity duration is 13 hours and the regular activity duration is 10 hours. And the time distance between the period end node 73 and the nearest standby start node 791 is 30 minutes which is less than 8 hours, wherein the threshold is satisfied when the time distance is less than 8 hours.

The server 1 calculating a total time differential between the period start node 75 and the standby end node 792. As the result, total activity duration is 13.5 hours.

At the fifth embodiment, the scheduled activity duration is the adding of the regular activity duration and the standby time differential between the standby start node 791 the standby end node 792. As the result, scheduled activity duration is 13.5 hours.

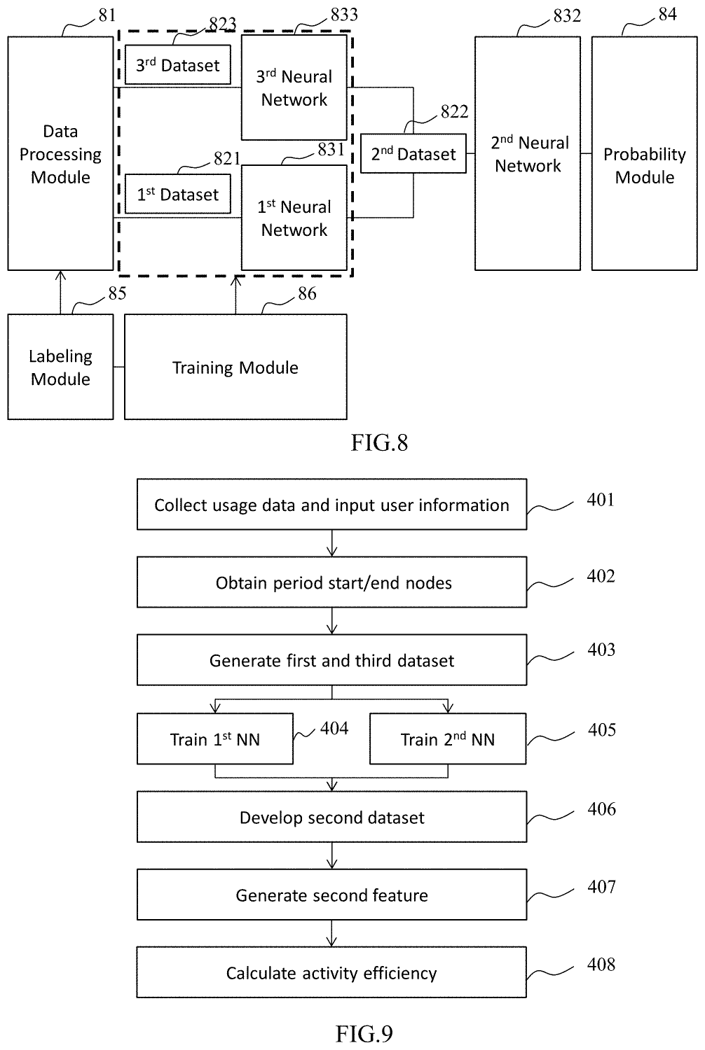

A diagram of the activity efficiency calculation system and the training system thereof is shown in FIG. 8. The activity efficiency calculation system comprises a data processing module 81, first neural network 831, second neural network 832, third neural network 831 and probability module 84. And the training system comprises a labeling module 85 and training module 86.

The data processing module 81 receives and encodes the usage data and the user information from the mobile device 2 into a neural network readable data. And the labeling module 85 labels the readable data as activity or non-activity. After then, the data processing module 81 set the encode-labeled usage data and user information as the first dataset 821 and the third dataset 823, respectively.

The training module 86 executes a first learning method comprises a 5-fold cross-validation approach by splitting the first dataset 821 and the third dataset 823 into 5 smaller sets, and each sets have 4 training dataset and 1 learning dataset.

The first neural network 831 generates a first feature based on the first dataset 821, and the third neural network 833 generates a third feature based on the third dataset 823, then the first feature and third feature concatenate together to develop the second dataset 822.

The third neural network 831 generates a third feature based on the second dataset 822, and the probability module 84 generates activity efficiency at a specific duration based on the third feature.

A sixth embodiment is an embodiment of the method for training activity efficiency calculation system is shown in FIG. 8. In the sixth embodiment, the method for training activity efficiency calculation system begins at step 401 when the mobile device 2 automatically collects the usage data of the user 3 every second, and the user inputs his user information to the mobile device 2, and the mobile device 2 transmits the user information to the activity efficiency calculation system installed inside the server 1.

The usage data is the user's mobile device usage behavior, especially the application name data, application category data, screen status data, notification data. Wherein, the application name data and application category data is collected according to the application which the user is utilizing, and the application category data is determined according to category which provided by the APP store or Google play. Wherein, the status data is collected according to the screen-on or the screen-off of the mobile device 2. Wherein, the notification data is the timestamp at which the user 3 receives a notification.

The user information is the age, gender, activity position, department of the position, range of activity, and type of the mobile device 2. Wherein the type of the mobile device 2 is sort by purpose. For a physician, the type of the mobile device 2 could be a public device which is public on a hospital's website, a private device which is public at the counter of his clinic, or personal device which is only known by the family and friends.

At step 402, the server 1 executes the method for calculating activity duration by running step 201-206. And the server 1 obtains a period start node which is set as working start node, and the period end node which is set as working end node.

At step 403, the processing module 81 generates first dataset and third dataset. The processing module 81 begins step 403 by receiving usage data and the user information. Then, the data processing module 81 encodes the application name data and application category data by one-hot encoding; the data processing module 81 encodes the screen status data, the notification data, gender, range of activity and type of the mobile device by label encoding. In the meantime, the data processing module 81 labels the usage data which the mobile device 2 collected during the working start node and the working end node as the first status, and the other usage data as second status. And the server 1 divides the encoded usage data and encoded user information into one data group every 3600 second.

After the dividing of the data group, the processing module 81 generates the label data by labeling all the encoded usage data in the data group as activity when the amount of the first status labeled user data in the data group is more than 1800, and the other encoded usage data is labeled as non-activity. Then the processing module 81 set the label data as first dataset and the encoded user information as third dataset.

At step 404, the training module 86 trains the first neural network 831, 1-dimension convolutional neural network, based on the first dataset 811 under a first learning method, wherein the first neural network 831 generates a first feature after the first learning method.

Wherein, the first learning method comprises a 5-fold cross validation approach, and the training dataset is set according to the pure data of the first dataset, and the testing dataset is set according to the original data of the first dataset. The pure data which is labeled as activity is obtain by sampling the first dataset which is collected during 1 hour after the period start node to the in-range node of 3 hours after the period start node. The pure data which is labeled as non-activity is obtain by sampling the first dataset which is collected during the period end node to the out-range nodes of 2 hours after the period start node.

At step 405, the training module 86 trains the third neural network 833, deep neural network, based on the third dataset 813 under a third learning method which also comprises a 5-fold cross validation approach, wherein the third neural network 831 generates a third feature after the third learning method.

At step 406, the first feature and the third feature concatenate to develop second dataset 832.

At step 407, the second neural network 832, deep neural network, generates the second feature based on the second dataset 832.

At step 408, the probability module 84, sigmoid function module, calculates the activity efficiency at every 10 minutes based on the second feature.

A graphic of the sixth embodiment is shown in FIG. 9. In the sixth embodiment, the activity efficiency calculation system calculates the activity efficiency at every 10 minutes based on the usage data and user information. As shown in the FIG. 9 the user 3 has the best efficiency at 11:00 and 15:00, the user would arranged the toughest activities at 11:00 and 15:00 according to the efficiency graphic.

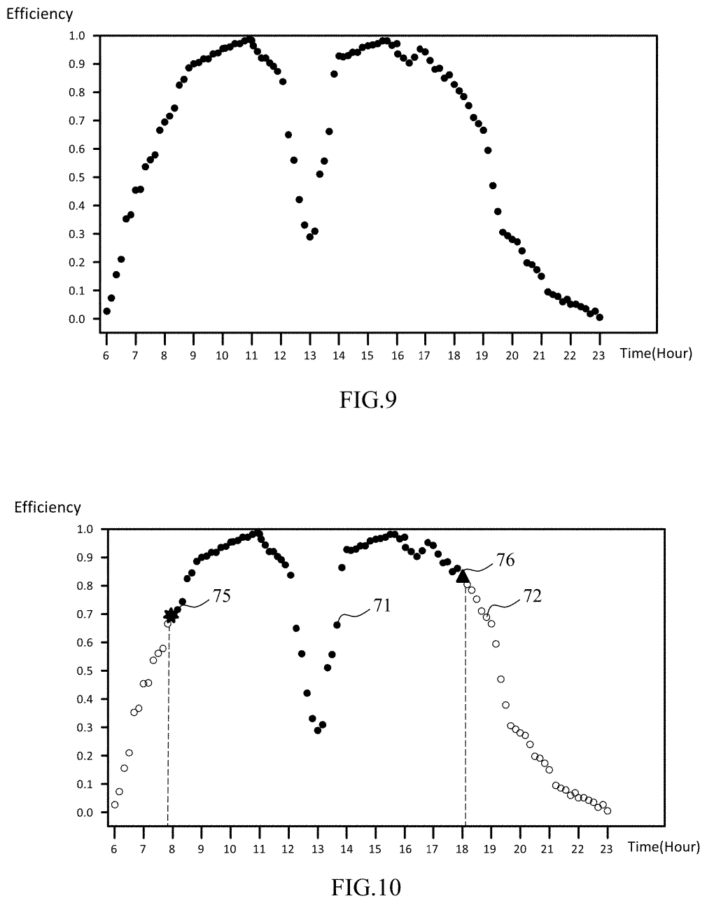

A graphic of method for calculating weighted activity duration is shown in FIG. 10. In the sixth embodiment, the user 3 could integrate the activity efficiency with the activity duration, and the area from the period start node 75 to the period end node 76 will be the weighted activity duration.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for calculating activity duration, the method comprising:
setting at least one range of activity;
collecting user data, wherein the user data comprises locations data and timestamp data of an user;
dividing the user data into in-range node and out-range node based on the range of activity;
setting the in-range node as an activity start node when the in-range node satisfies a first condition;
setting the in-range node as an activity end node when the in-range node satisfies a second condition;
setting the activity start node as a period start node when the activity start node satisfies a third condition;
setting the activity end node as a period end node when the activity end node satisfies a fourth condition;
calculating a period time differential between the period start node and the nearest period end node after the period start node;
let the period time differential be the first activity duration.

2. The method of claim 1 further comprising:
setting a regular start node and a regular end node;
calculating a regular time differential between the regular start node and the regular end node;
let the regular time differential be the regular activity duration;
calculating an overtime differential by subtracting the first activity duration with the regular activity duration;
let the overtime differential be the overtime activity duration.

3. The method of claim 2 further comprising:
setting a standby start node, and a standby end node;
calculating a total time differential between the period start node and the standby end node;
let the total activity duration be the total time differential when the time distance between the period end node and the nearest standby start node of the period end node satisfied the threshold;
let the total activity duration be the first activity duration when the time distance between the period end node and the nearest standby start node of the period end node is not satisfied the threshold.

4. The method of claim 3 further comprising:
calculating a standby time differential between the standby start node and the standby end node;
calculating a scheduled activity duration by adding the regular time differential with the standby time differential.

5. The method of claim 1, wherein the first condition is satisfied when more than a first quantity of continuous out-range nodes disposed adjacently to the front of the in-range node, and more than a second quantity of continuous in-range nodes disposed adjacently to the back of the in-range node; or
no user data is collected before the in-range node, and more than a second quantity of continuous in-range nodes disposed adjacently to the back of the in-range node.

6. The method of claim 1, wherein the second condition is satisfied when more than a second quantity of continuous out-range nodes disposed adjacently to the back of the in-range node; or
no user data is collected after the in-range node.

7. The method of claim 1, wherein the third condition is satisfied when no activity start node is set before the activity start node; or
the activity start node exists a first out-range time differential, and the first out-range time differential satisfied a threshold;
wherein, the activity start node exists the first out-range time difference when one of the out-range nodes is adjacent to the activity start node, and the first out-range time differential is the time differential between the activity start node and the nearest activity end node before the activity start node.

8. The method of claim 1, wherein the fourth condition is satisfied when no activity end node is set after the activity start node; or
the activity end node exists a second out-range time difference, and the second out-range time differential satisfied a threshold;
wherein, the activity end node exists the second out-range time difference when one of the out-range nodes is adjacent to the activity end node, and the second out-range time differential is the time differential between the activity end node and the nearest activity start node after the activity end node.

9. A method for training activity efficiency calculation system, the method comprising:
collecting usage data, wherein the usage data is the user's mobile device usage behavior;
generating a label data by labeling the usage data as activity or non-activity, and setting the label data as a first dataset;
training the first neural network based on the first dataset under a first learning method, which generates a first feature;
training the second neural network based on a second dataset under a second learning method, which generates a second feature; and
calculating a activity efficiency based on the second feature under a probability module;
wherein the second dataset comprises the first feature.

10. The method of claim 8, wherein the steps of labeling the usage data is comprises:
setting a working start node and a working end node with the method of claim 1;
labeling the usage data collected during the working start node and the working end node after the start node as first status;
labeling the usage data which is not labeled as the first status as a second status;
dividing the usage data into data groups based on the timeline;
labeling the usage data as activity when the amount of the first status data of the data group satisfies a fifth condition; and
labeling the usage data which is not labeled as the activity as the non-activity;
wherein, the first status data is the usage data which is labeled as the first status.

11. The method of claim 10, wherein the steps of labeling the usage data is comprises:
defining a period start node and a period start node with the method of claim 1;
setting the period start node as the working start node;
setting the period end node as the working end node;

12. The method of claim 10, further comprising:
receiving a user information of a user;
setting the user information as a third dataset;
training the third neural network based on the third dataset under a third learning method, which generates a third feature;
adding the third feature into the second dataset, and concatenate the third feature and the first feature.

13. The method of claim 12, wherein the third learning method comprising a cross validation approach.

14. The method of claim 12, wherein the third neural network is a deep neural network.

15. The method of claim 12, wherein the user information is the age, gender, activity position, department of the position, range of activity, type of the mobile device, or combination of any two mentioned above, wherein the type of the mobile device is public device, private device or personal device.

16. The method of claim 8, wherein the first learning method comprising a cross validation approach.

17. The method of claim 8, wherein the first neural network is a convolutional neural network.

18. The method of claim 8, wherein the second neural network is a deep neural network.

19. The method of claim 8, wherein the usage data is application name data, application category data, screen status data, notification data, or combination of any two mentioned above according to the usage of a mobile device by the user at each timepoint.

20. A method for calculating weighted activity duration, the method comprising:
obtaining the period start node and the period start node with the method of claim 1;
obtaining an activity efficiency during the period start node and the nearest period end node after the period start node with the method of claim 8;
calculating the weighted activity duration based on activity efficiency, the period start node and the period start node.
